(19) United States
(12) Patent Application Publication
(10) Pub. No.: US 2020/0071981 A1
(43) Pub. Date: Mar. 5, 2020

(54) WINDOW LIFTER ASSEMBLY FOR ADJUSTING A WINDOW PANE

(71) Applicant: Brose Fahrzeugteile GmbH & Co. Kommanditgesellschaft, Bamberg, Bamberg (DE)

(72) Inventors: Nathan BEADLE, Royal Oak, MI (US); Michael KIDD, Oxford, MI (US); Thomas MIESSNER, Gevelsberg (DE)

(21) Appl. No.: 16/118,519

(22) Filed: Aug. 31, 2018

(51) Int. Cl. E05F 11/48; F16N 15/02; C10M 103/02

(52) U.S. Cl. CPC E05F 11/483; F16N 15/02; C10M 103/02; E05Y 2900/55; C10M 2213/062; E05Y 2201/654; E05Y 2201/684; C10M 2201/066; E05Y 2201/668

(57) ABSTRACT

A window lifter assembly for adjusting a window pane comprising a rail defining a track, a slider coupled to and configured to translate along the track to move the window pane, a pulley rotatably coupled the rail, and a cable wound around the pulley and operatively connected to the slider so that movement of the cable rotates the pulley and moves the window pane, wherein the pulley is provided with an anti-friction coating that is configured to form a bearing surface between the pulley and an untreated portion of the rail.

### TECHNICAL FIELD

The present state of the art for window regulators, in particular regulators with aluminium or steel rails, is to use a coating (powder coating) on the rails to prevent noise and allow for durability and performance through temperatures and environments.

### BACKGROUND

Window lifter assemblies for adjusting a window pane, e.g., in a motor vehicle are quite well known. Typically, window lifter assemblies comprise a rail, a slider, that is attachable to the window pane and movable along the rail, at which the at least one slider is slidably arranged, a flexible traction member for applying a movement force to the at least one slider in order to slide the slider along the at least one rail and at least one guiding member, for example in the form of a pulley, via which the traction member is guided from a first direction towards a second direction. The flexible traction member may be connected to a drive unit which typically includes a cable drum. By rotating the cable drum and thereby winding and unwinding portions of the flexible traction member at the cable drum a movement force is applied to the slider so a force is applied to the window pane, moving the window pane upwards or downwards.

In the industry it is known to make a rail for a window lifter assembly of a metal material, for example of aluminium. To mitigate noise during operation, the rail is powder coated. Furthermore, grease may be applied to the rails. Both, the powder coating of the rail and the application of grease may increase costs for manufacture and assembly of the window lifter assembly.

### SUMMARY

A window lifter assembly for adjusting a window pane comprising a rail defining a track, a slider coupled to and configured to translate along the track to move the window pane, a pulley rotatably coupled the rail, and a cable wound around the pulley and operatively connected to the slider so that movement of the cable rotates the pulley and moves the window pane, wherein the pulley is provided with an anti-friction coating that is configured to form a bearing surface between the pulley an untreated portion of the rail.

In one embodiment the anti-friction coating is comprised of a solvent that is configured to dry and decrease a coefficient of friction of the pulley after application. The applied anti-friction coating thus in particular decreases a coefficient of friction between the pulley and the rail to which the pulley is rotatably coupled. By applying the anti-friction coating, powder coating parts of or all of the rail may be eliminated. Also, the anti-friction coating may facilitate eliminating the application of grease to one or more of the window lifter components. The elimination of powder coating and the grease may be accomplished without unwanted side effects e.g., noise, higher operational efforts. In one or more embodiments, the elongated rail may be comprised of one or more metal materials, e.g., aluminium, steel, or other suitable materials.

In one embodiment the slider is provided with an anti-friction coating that is configured to migrate from an intermediary surface between the slider and a second untreated portion of the rail and/or the anti-friction coating is configured to migrate from the pulley to an untreated portion of the rail.

In one embodiment, an untreated portion of the rail does not include powder coating.

In one embodiment the anti-friction coating comprises molybdenum disulphide. The anti-friction coating may also comprise a lubricant solution. Such a lubricant solution may for example contain solid lubricants, resins (for example, as bonding agents) and solvents. Components of a solid lubricant may for example be molybdenum disulphide, graphite and PTFE.

A further aspect of the proposed solution relates to a method of assembling a window lifter assembly comprising attaching a pulley to an elongated rail such that it is rotatably coupled to the rail, and applying an anti-friction coating to the pulley off-line from the attaching of the pulley to the rail.

The applying step may be accomplished by dip spinning. Dip spinning in this context, may involve placing the pulley into a container, submerging the container, and rotating the container at a predetermined speed to remove excess coating.

In one embodiment, the method further comprises applying a mineral based dry oil to the elongated rail off-line from and before attaching the pulley.

A further aspect of the proposed solution relates to a method of assembling a window lifter assembly comprising attaching a slider to a cable and to an elongated rail such that the slider is movable along the elongated rail, and applying an anti-friction coating to the slider, wherein the anti-friction coating is applied off-line from the attaching of the slider to the rail.

For example, using an anti-friction coating based on a lubricant solution allows for an effective application of the anti-friction coating to the relevant portions of the at least one slider and/or the at least one guiding member.

### BRIEF DESCRIPTION OF THE DRAWINGS

The previously mentioned and other advantages of the present solution will be apparent to those skilled in the art upon consideration of the following specification and the attached drawings.

FIG. 1 is a side view of an exemplary embodiment of a window lifter assembly comprising (a) two rails at each of which a slider is slidably arranged and (b) a cable which is a guided via four different guiding members in the form of the pulleys.

FIG. 2 is a side view of one of the pulleys of the window lifter assembly of FIG. 1 showing the pulley having an anti-friction coating in greater detail.

FIG. 3 is a perspective view of one of the rails of FIG. 1 to which pulleys are mounted and of the slider associated with the rail in an unmounted state.

FIG. 4 is perspective view of a prior art rail with pulleys and of a separate prior art slider.

### DETAILED DESCRIPTION

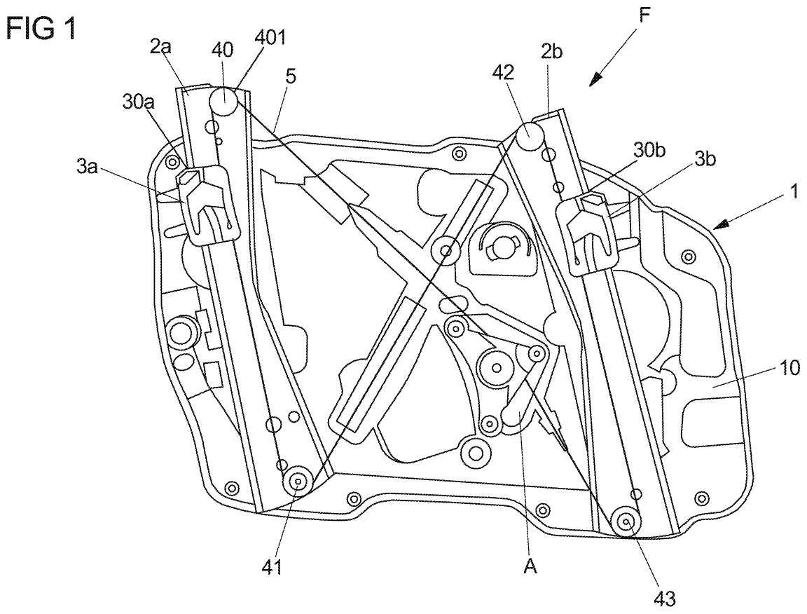

FIG. 1 shows an exemplary embodiment of a window lifter assembly F according to the proposed solution. The window lifter assembly F of FIG. 1 comprises a plate-like carrier member 1 at which different functional components of the window lifter assembly F are mounted. The carrier member 1 defines an outer surface 10 at which, for example, two elongated (guide) rails 2a and 2b are fixed. Each of the rails 2a, 2b carries a slider 3a or 3b. Each of the sliders 3a, 3b is slidably arranged at the corresponding rail 2a or 2b and is a configured to be connected to a window pane.

Each of the sliders 3a, 3b is connected to a flexible traction member in the form of a cable 5. This cable 5, for example in the form of a Bowden cable, is connected to a drive unit A which is arranged between the two rails 2a, 2b and fixed to the carrier member 1. Due to the drive unit A driving force may be transferred to the cable 5 resulting in a movement force pulling the pair of sliders 3a, 3b upwards or downwards alone their rails 2a, 2b.

In order to move the two sliders 3a, 3b synchronously the single cable 5 is deflected several times at guiding members of the window lifter assembly F. Each guiding member is provided in the form of a rotatably mounted pulley 40, 41, 42 or 43. Each rail 2a, 2b carries one pair of pulleys 40, 41 or 42, 43, wherein in each case a first pulley 40 or 42 is mounted at an upper end of the respective rail 2a or 2b and a second pulley 41 or 43 is mounted at a lower end of the respective rail 2a or 2b.

Via each pulley 40, 41, 42, 43 the cable 5 is guided from of a first direction towards a different second direction so that the portions of the cable 5 run along both rails 2a and 2b and intersect between the two rails 2a, 2b. Thereby, winding and unwinding portions of the cable 5 at a cable drum of the drive unit A—depending on a direction of rotation of the cable drum—forces the sliders 3a and 3b to move upwards or downwards along the rails 2a, 2b.

Whereas rails 2a, 2b are typically made of a metal material, like aluminium, and are powder coated and greased in order to allow for a smooth sliding movement of the sliders 3a, 3b along the rails 2a, 2a, the metal rails 2a, 2b of the window lifter assembly F illustrated in FIG. 1 are both grease-free and/or powder coating free. In order to nevertheless allow for a noise free operation of the window lifter assembly F at least one of a slider interface 30a, 30b of a slider 3a, 3b and a guiding surface 401 of a pulley 40, 41, 42, 43 is provided with an anti-friction coating.

Via a slider interface 30a, 30b a respective slider 3a, 3b contacts its corresponding rail 2a, 2b. In general, a slider interface 30a, 30b relates to a portion of a slider 3a or 3b via which the slider 3a or 3b slidably contacts its corresponding rail 2a or 2b and which may be provided with an anti-friction coating in order to reduce friction between the rail 2a, 2b and the slider 3a, 3b during a movement of the slider 3a, 3b along the rail 2a, 2b. The slider interface 30a, 30b may, for example, be provided at a portion of a slider 3a or 3b via which the slider 3a, 3b engages around a lateral part of a rail 2a, 2b and which thus may be U-shaped in cross-section

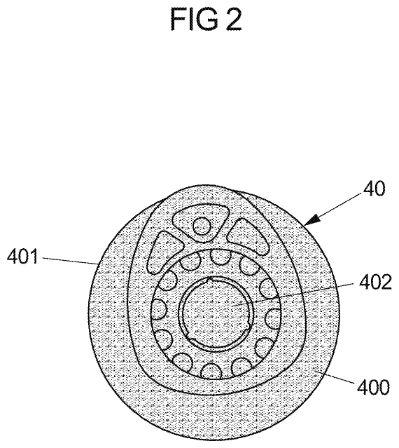

Providing a pulley 40, 41, 42, 43 with an anti-friction coating also allows for a further reduction in friction during an adjustment of a slider 3a, 3b and thus during adjustment of a window pane connected to the sliders 3a and 3b. The anti-friction coating may be in particular provided at an interface of a pulley 40, 41, 42, and 43 and its respectively associated rail 2a or 2b in order to reduce friction between the rotatable pulley 40, 41, 42, 43 and the associated rail 2a or 2b. The anti-friction coating may also be provided at a contact surface of a through hole 402 via which the pulley 40, 41, 42, 43 is rotatably mounted to its associated rail 2a or 2b and a guiding surface 401 as shown in FIG. 2 for exemplary pulley 40 (being identical to the other pulleys 41, 42 and 43). The guiding surface 401 is provided by a circumferential channel at the pulley 40 in which the cable 5 is guided and deflected by more than 135° in the mounted window lifter assembly F. The guiding surface 401 is provided at a pulley body 400 comprising a through hole 402 via which the pulley 40 is rotatably mounted to its associated rail 2a.

In order to facilitate application of the anti-friction coating the complete pulley 40 of FIG. 2 is provided with the anti-friction coating by immersion, spraying or a dip spin process. A dip spin process in this context may involve placing the pulley 40 into a container, submerging the container, and rotating the container at a predetermined speed to remove excess coating. A typical dip spin process may, for example, encompasses three steps: 1.) Cleaning and pretreatment of the pulley 40; 2.) Application of the anti-friction coating; and 3.) Curing. After drying, the pulley 40 may be loaded into a wire-mesh lined basket and then transferred into a dip/spin chamber, where the pulley 40 is locked onto a rotating spin platform. A coating container, positioned directly below, is then raised to submerge the basket of the pulley 40 in the coating. When immersion time is complete, the coating container drops to a point where the basket is still in the container, but above the liquid level. The basket is then centrifuged. A common spin cycle could, for example, be one direction for 20 to 30 seconds, a full brake, then reverse spin for an equal duration. The braking action re-orients parts to efficiently remove coatings from recesses. When dip/spin is complete, the coating vessel is fully lowered and the basket is realigned, unlocked and removed. Cure cycles range from 5 to 30 minutes.

Generally, the applied anti-friction coating may be comprised of a lubricant solution or lubricating paint. Anti-friction coatings may provide a dry, slippery film that improves surface roughness and optimizes friction on a wear surface, even under relatively high loads or extreme operating conditions (e.g., high temperature, sub-zero temperatures). Anti-friction coatings may have a wide temperature range offering performances that isn't hindered in a normal automotive range of −40 C to 250 C. Anti-friction coatings are generally made of a resin and binder system, solid lubricants, and a carrier such as water or a solvent. Anti-friction coatings may cure in different ways, including but not limited to an ambient cure or heat cure.

Such a lubricant solution may contain lubricants, resins, and solvents. In particular, the lubricant solution may comprise lubricant components like molybdenum disulphide, graphite, and PTFE that provide for good results regarding a smooth and noise free operation of the window lifter assembly F if the corresponding anti-friction coating is applied to a slider interface and/or pulleys 40 to 43 made of plastics, in particular molded plastics.

A mineral based dry oil may additionally be applied to an elongated rail 2a, 2b off-line from and before attaching the associated (coated) pulleys 40 to 43. The mineral based dry oil may, for example, be applied to a rail 2a, 2b at approximately 70° C. and, for example, using an electrostatic oiler. A mineral based dry oil which may be applied may contain wax components and may be free from water and of solvents; be resistant to ageing and be biodegradable. In one embodiment, the mineral based dry oil is directly applied onto a metal (e.g., steel) sheet material of which a rail 2a or 2b is made. For a stamped rail 2a, 2b a stamper may thus receive pre-coated coil material.

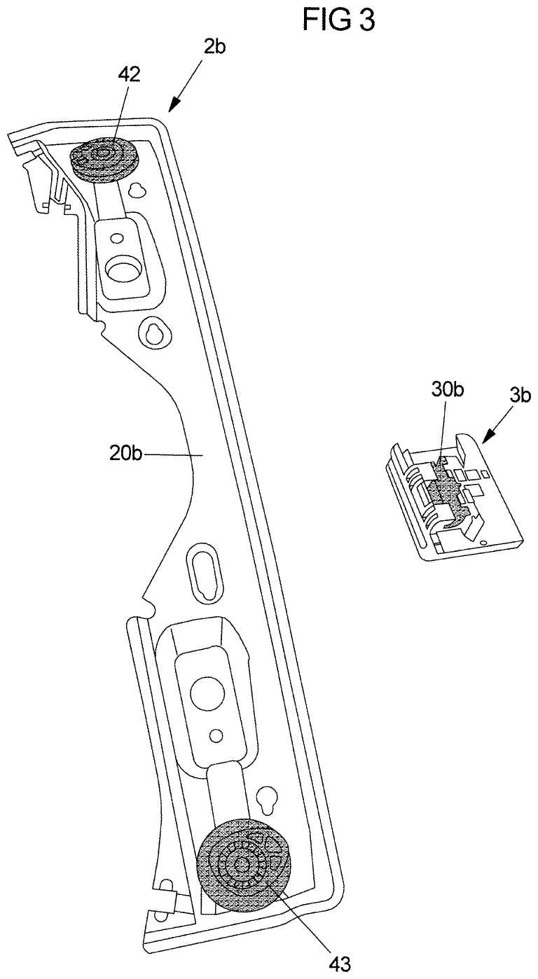

In FIG. 3 one of the rails 2a, 2b of the window lifter assembly F of FIG. 1 is shown in greater detail. FIG. 3 also shows in greater detail the slider 3b associated with the rail 2b shown in FIG. 3.

The metal rail 2b of FIG. 3 is left uncoated and carries the two pulleys 42 and 43 at its corresponding ends. Those pulleys 42, 43 are provided with an anti-friction coating. This coating is respectively applied, for example, by a dip spin process and then baked on the respective pulley 42, 43. In contrast to the rail 2b the pulleys 42 and 43 are made of a plastic material, for example Polyoxymethylene (POM). In order to save costs at least one of the pulleys 42, 43 may also be made of Nylon PA 6 or PA66 given that a more expensive material like friction modified POM resulting in lower friction is no longer required due to the anti-friction coating.

FIG. 3 also shows the slider 3b which is to be mounted to the rail 2b and which—in a mounted state—may slide along the rail 2b. The slider 3B comprises a slider body which defines the slider interface 30b via which the slider 3b contacts a guiding portion at the lateral part of the rail 2b which guiding portion may be L-shaped in cross-section. The slider interface 30b is also provided with an anti-friction coating. For example, the anti-friction coating may be applied by a dip spin process and then baked onto the slider 3b at its slider interface 30b. Again, the slider 3b, in particular its slider body, can be made of a plastic material, like POM or—for further cost savings—PA 6/PA 66.

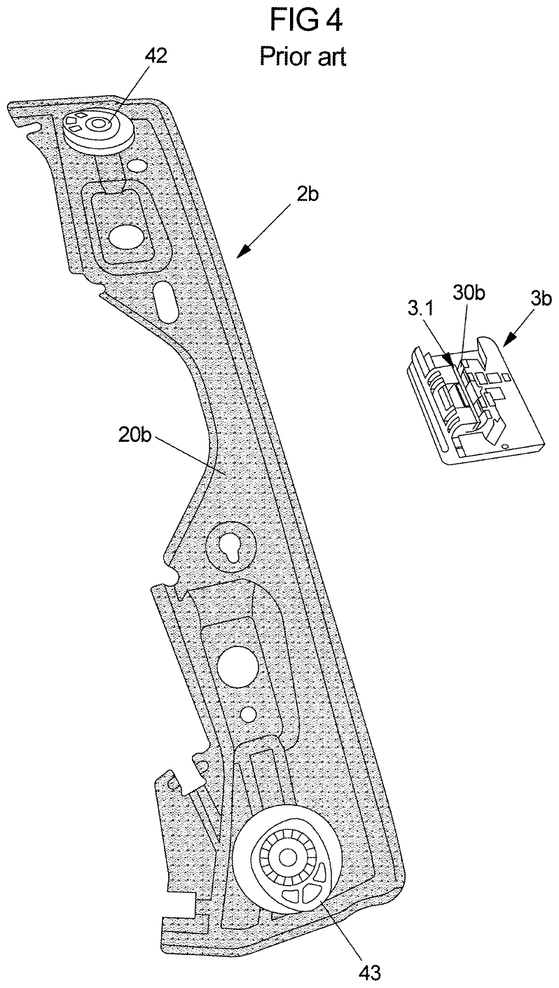

FIG. 4 shows a prior art solution with a metal rail 2b and a slider 3b associated therewith. In contrast to the proposed solution the prior art rail 2b of FIG. 4 is completely coated. Whereas a surface 20b of the rail 2b of FIG. 3 is completely left uncoated, a coating is applied to the prior art rail 2b of FIG. 4 over its entire surface 20b. In contrast thereto, the plastic pulleys 42 and 43 are uncoated in the prior art solution of FIG. 4. The same holds true for the slider 3b.

In case of the prior art slider 3b of FIG. 4 the slider interface 30b is provided by a clip 3.1 which is mounted to the slider body and for example made of a friction modified plastic material. Whereas the prior art window lifter assembly with rail 2b, pulleys 42 and 43 and slider 3b as shown in FIG. 4 considers a fully (powder) coated metal rail 2b (be manufactured for example based on aluminium or steel) essential for preventing noise and allowing for durability and performance through temperatures and environments, an exemplary embodiment of the proposed solution might focus on just applying an anti-friction coating to smaller components, like the pulleys 40 to 43, and/or to specific areas of such components, like to the slider interface 30a, 30b of a slider 3a, 3b of a window lifter assembly F. Thereby, also applying a general purpose commodity grease at an interface of the rail for a pulley and/or at a slider interface may be avoided which, in general, is sometimes considered beneficial with respect to reducing friction in operation of the window lifter assembly but may render manufacturing and assembly processes more complex.

In the embodiments described the anti-friction coating may provide a bearing surface or intermediary surface between the elongated rail 2a or 2b and pulley 40, 41, 42, 43 as well as the slider 3a, 3b. Accordingly, the anti-friction coating may, for example, in particular be configured to form a bearing surface between a pulley 40, 41, 42, 43 and an untreated portion of a rail 2a or 2b. The sliders 3a, 3b may be provided with an anti-friction coating that is configured to migrate from an intermediary surface between the respective slider 3a or 3b and a second untreated portion of the rail 2a or 2b to which the slider 3a or 3b is attached. A pulley 40, 41, 42, 43 may be provided with an anti-friction coating that is configured to migrate from the pulley 40, 41, 42, or 43 to an untreated portion of the associated rail 2a or 2b. The anti-friction coating may thus, for example, be configured to be at least partially rubbed off from the pulley during operation of the window lifter assembly F thereby disposing anti-friction coating on a untreated portion of the associated rail 2a or 2b. Likewise, the sliders 3a, 3b may be provided with an anti-friction coating that is configured to migrate from the slider 3a or 3b to a second untreated portion of the associated rail 2a or 2b.

What is claimed is:

1. A window lifter assembly for adjusting a window pane comprising:
a rail defining a track;
a slider coupled to and configured to translate along the track to move the window pane;
a pulley rotatably coupled the rail; and
a cable wound around the pulley and operatively connected to the slider so that movement of the cable rotates the pulley and moves the window pane, wherein the pulley is provided with an anti-friction coating that is configured to form a bearing surface between the pulley and an untreated portion of the rail.

2. The window lifter assembly of claim 1, wherein the anti-friction coating is comprised of a solvent that is configured to dry and decrease a coefficient of friction of the pulley after application.

3. The window lifter assembly of claim 2, wherein the anti-friction coating comprises molybdenum disulphide

4. The window lifter assembly of claim 1, wherein anti-friction coating is applied to the pulley by a dip spin process.

5. The window lifter assembly of claim 1, wherein the slider is provided with an anti-friction coating that is configured to migrate from an intermediary surface between the slider and a second untreated portion of the rail.

6. The window lifter assembly of claim 5, wherein anti-friction coating is applied to the pulley by a dip spin process.

7. The window lifter assembly of claim 1, wherein the untreated portion of the rail does not include powder coating.

8. The window lifter assembly of claim 1, wherein the anti-friction coating is configured to migrate from the pulley to an untreated portion of the rail.

9. A method of assembling a window lifter assembly comprising:
attaching a pulley to an elongated rail such that it is rotatably coupled to the rail; and
applying an anti-friction coating to the pulley off-line from the attaching of the pulley to the rail.

10. The method of claim 9, wherein the applying step is accomplished by dip spinning.

11. The method of claim 10, wherein the dip spinning involves placing the pulley into a container, submerging the container, and rotating the container at a predetermined speed to remove excess coating.

12. The method of claim 9, applying a mineral based dry oil to the elongated rail off-line from and before attaching the slider.

13. The method of claim 9, further comprising:
attaching a slider to a cable and to an elongated rail such that the slider is movable along the elongated rail; and
applying an anti-friction coating to the slider, wherein the anti-friction coating is applied off-line from the attaching of the slider to the rail.

14. The method of claim 13, further comprising:
applying a mineral based dry oil to the elongated rail off-line from and before attaching the slider.

15. A method of assembling a window lifter assembly comprising:
attaching a slider to a cable and to an elongated rail such that the slider is movable along the elongated rail; and
applying an anti-friction coating to the slider, wherein the anti-friction coating is applied off-line from the attaching of the slider to the rail.

16. The method of claim 15, wherein the applying step is accomplished by dip spinning.

17. The method of claim 15, further comprising:
attaching a pulley to an elongated rail such that it is rotatably coupled to the rail; and
applying an anti-friction coating to the pulley off-line from the attaching of the pulley to the rail.

18. The method of claim 17, wherein the applying step is accomplished by dip spinning.

19. The method of claim 18, wherein the dip spinning involves placing the pulley into a container, submerging the container, and rotating the container at a predetermined speed to remove excess coating.

20. The method of claim 15, further comprising:
applying a mineral based dry oil to the elongated rail off-line from and before attaching the slider.
